(19) United States
(12) Patent Application Publication
(10) Pub. No.: US 2023/0118407 A1
(43) Pub. Date: Apr. 20, 2023

(54) SYSTEMS AND METHODS FOR AUTONOMOUS TESTING OF COMPUTER APPLICATIONS

(71) Applicant: FIDELITY INFORMATION SERVICES, LLC, Jacksonville, FL (US)

(72) Inventors: Rajiv RAMANJANI, Bengaluru (US); Shefali GARG, Bengaluru (IN)

(73) Assignee: FIDELITY INFORMATION SERVICES, LLC, Jacksonville, FL (US)

(21) Appl. No.: 18/066,716

(22) Filed: Dec. 15, 2022

Related U.S. Application Data
(63) Continuation of application No. 17/158,404, filed on Jan. 26, 2021.

(30) Foreign Application Priority Data
Dec. 8, 2020 (IN) 202011053297

(51) Int. Cl. G06F 11/36; G06N 20/00; G06F 18/214; G06F 18/21

(52) U.S. Cl. CPC G06F 11/3688; G06F 11/3692; G06N 20/00; G06F 11/3684; G06F 18/214; G06F 18/2178

(57) ABSTRACT

Methods and systems for autonomous testing of a computer application include receiving analytic data associated with at least one application programming interface (API) flow, wherein an API flow of the at least one API flow includes at least one API; determining response data of the at least one API by inputting the analytic data to a prediction model determined based on a first machine learning technique; determining a subset of the at least one API flow based on the response data and input data representing at least one of a priority level or a risk level of the at least one API flow; and outputting the subset of the at least one API flow for execution.

### CROSS-REFERENCE TO RELATED APPLICATION(S)

This applications claims priority to Indian Patent Application 202011053297, filed on Dec. 8, 2020, the content of which is incorporated by reference herein in its entirety.

### TECHNICAL FIELD

The present disclosure generally relates to computerized methods and systems for autonomous testing of computer applications and, more particularly, to computerized methods and systems for autonomously and automatically generating testing solutions to validate and optimize flows for implementing the computer applications in a development phase of computer applications.

### BACKGROUND

Many business providers (e.g., financial service provider) use a client-server model (e.g., a cloud service model) for providing computerized services (e.g., banking services) to customers. In some cases, a computerized service may be implemented by multiple, different sequences of operations (referred to as “business flows”). The client-server model may deploy a computer application at a server for implementing the computerized service. The computer application may include one or more application programming interfaces (“APIs”) combined in a specific manner to implement the computerized service, which may be referred to as an “API product suite.”

In a development phase, testing schemes may be generated for validating the computer application. Existing solutions require great effort (e.g., by a quality assurance team) for identifying and reviewing possible business flows of the computerized service, for designing the testing schemes of the computer application corresponding to the identified business flows, and writing the testing scripts for running the testing schemes. Also, existing solutions require great effort to create and maintain program codes (e.g., scripts) and testing data for testing the computer application. Further, when the computer application has a change or a new function, existing solutions may require efforts to update and maintain the program codes and the testing data.

Existing solutions have technical problems because such efforts are complicated to implement and prone to generate gaps in covering all testing scenarios. Moreover, when the possible business flows of the computerized service are numerous, existing solutions may face challenges in effectively categorizing the business flows and efficiently deciding which business flows would succeed or fail, which may further limit the testing and development efficiency, especially in identification of similar defect patterns in the computer applications, identification of error-prone business flows, prioritization of the business flows, and analyzing impact of the change or new function of the computer application.

### SUMMARY

One aspect of the present disclosure is directed to a system for autonomous testing of a computer application. The system includes a non-transitory computer-readable medium configured to store instructions and at least one processor configured to execute the instructions to perform operations. The operations include receiving analytic data associated with at least one application programming interface (API) flow, wherein an API flow of the at least one API flow comprises at least one API; determining response data of the at least one API by inputting the analytic data to a prediction model determined based on a first machine learning technique; determining a subset of the at least one API flow based on the response data and input data representing at least one of a priority level or a risk level of the at least one API flow; and outputting the subset of the at least one API flow for execution.

Other aspects of the present disclosure are directed to computer-implemented methods for performing the functions of the systems discussed above.

Other systems, methods, and computer-readable media are also discussed herein.

### BRIEF DESCRIPTION OF THE DRAWINGS

FIG. 1 is a diagram of an example server computer system for autonomous testing of a computer application, consistent with some embodiments of this disclosure.

FIG. 2 is a diagram of an example structure of an API flow optimizer for autonomous testing of a computer application, consistent with some embodiments of this disclosure.

FIG. 3 is a diagram of an example structure of an API flow generator for autonomous testing of a computer application, consistent with some embodiments of this disclosure.

FIG. 4 is a diagram of an example structure of an API flow executor for autonomous testing of a computer application, consistent with some embodiments of this disclosure.

FIG. 5 is a flow diagram involving a testing module in the system shown in FIG. 1 for autonomous testing of a computer application, consistent with some embodiments of this disclosure.

FIG. 6 is a flowchart of an example process for autonomous testing of a computer application using the system shown in FIG. 1, consistent with some embodiments of this disclosure.

### DETAILED DESCRIPTION

The disclosed embodiments include systems and methods for classification and rating of calls based on voice and text analysis. Before explaining certain embodiments of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the accompanying drawings, are for the purpose of description and should not be regarded as limiting.

As such, those skilled in the art will appreciate that the conception upon which this disclosure is based may readily be utilized as a basis for designing other structures, methods, and systems for carrying out the several purposes of the present disclosure.

Reference will now be made in detail to the present example embodiments of the disclosure, examples of which are illustrated in the accompanying drawings. Wherever possible, the same reference numbers will be used throughout the drawings to refer to the same or like parts.

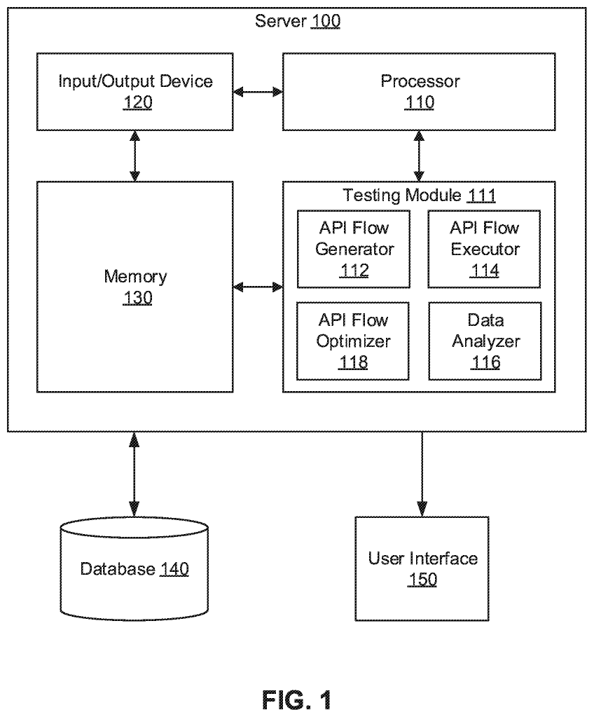

FIG. 1 is a block diagram of an example server computer system 100 (referred to as “server 100” hereinafter), consistent with some embodiments of this disclosure. Server 100 may be one or more computing devices configured to execute software instructions stored in memory to perform one or more processes consistent with some embodiments of this disclosure. For example, server 100 may include one or more memory devices for storing data and software instructions and one or more hardware processors to analyze the data and execute the software instructions to perform server-based functions and operations (e.g., back-end processes). The server-based functions and operations may include autonomous testing of a computer application.

In FIG. 1, server 100 includes a hardware processor 110, an input/output (I/O) device 120, and a memory 130. It should be noted that server 100 may include any number of those components and may further include any number of any other components. Server 100 may be standalone, or it may be part of a subsystem, which may be part of a larger system. For example, server 100 may represent distributed servers that are remotely located and communicate over a network.

Processor 110 may include or one or more known processing devices, such as, for example, a microprocessor. In some embodiments, processor 110 may include any type of single or multi-core processor, mobile device microcontroller, central processing unit, or any circuitry that performs logic operations. In operation, processor 110 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in memory 130, processor 110, or elsewhere.

I/O device 120 may be one or more devices configured to allow data to be received and/or transmitted by server 100. I/O device 120 may include one or more customer I/O devices and/or components, such as those associated with a keyboard, mouse, touchscreen, display, or any device for inputting or outputting data. I/O device 120 may also include one or more digital and/or analog communication devices that allow server 100 to communicate with other machines and devices, such as other components of server 100. I/O device 120 may also include interface hardware configured to receive input information and/or display or otherwise provide output information. For example, I/O device 120 may include a monitor configured to display a customer interface.

Memory 130 may include one or more storage devices configured to store instructions used by processor 110 to perform functions related to disclosed embodiments. For example, memory 130 may be configured with one or more software instructions associated with programs and/or data.

Memory 130 may include a single program that performs the functions of the server 100, or multiple programs. Additionally, processor 110 may execute one or more programs located remotely from server 100. Memory 130 may also store data that may reflect any type of information in any format that the system may use to perform operations consistent with disclosed embodiments. Memory 130 may be a volatile or non-volatile (e.g., ROM, RAM, PROM, EPROM, EEPROM, flash memory, etc.), magnetic, semiconductor, tape, optical, removable, non-removable, or another type of storage device or tangible (i.e., non-transitory) computer-readable medium.

Consistent with some embodiments of this disclosure, server 100 includes a testing module 111 that may include an API flow generator 112, an API flow executor 114, a data analyzer 116, and an API flow optimizer 118. Testing module 111 may be configured to test and optimize a computer application (e.g., APIs included in the computer application) autonomously and automatically using API flow generator 112, API flow executor 114, data analyzer 116, and API flow optimizer 118. Testing module 111 may be implemented as software (e.g., program codes stored in memory 130), hardware (e.g., a specialized chip incorporated in or in communication with processor 110), or a combination of both.

API flow generator 112 may be configured to automatically generate one or more combinations of APIs for implementing the computer application. API flow executor 114 may be configured to generate testing data and execute the one or more combinations of APIs using the testing data. Data analyzer 116 may be configured to analyze execution data resulting from the executing the one or more combinations of APIs and generate analytic data. API flow optimizer may be configured to optimize the one or more combinations of APIs based on the analytic data, such as by identifying a subset of the combinations of APIs that may implement the computer application with higher efficiency, lower complexity, and lower proneness to errors. In some embodiments, at least one of API flow generator 112, API flow executor 114, data analyzer 116, or API flow optimizer 118 may be organized or arranged separately from testing module 111. In further embodiments, at least one of API flow generator 112, API flow executor 114, data analyzer 116, or API flow optimizer 118 may be combined into one module serving the same functions.

Server 100 may also be communicatively connected to one or more databases 140. For example, server 100 may be communicatively connected to database 140. Database 140 may be a database implemented in a computer system (e.g., a database server computer). Database 140 may include one or more memory devices that store information (e.g., the execution data outputted by API flow executor 114) and are accessed and/or managed through server 100. By way of example, database 140 may include Oracle™ databases, Sybase™ databases, or other relational databases or non-relational databases, such as Hadoop sequence files, HBase, or Cassandra. Systems and methods of disclosed embodiments, however, are not limited to separate databases. In one aspect, server 100 may include database 140. Alternatively, database 140 may be located remotely from the server 100. Database 140 may include computing components (e.g., database management system, database server, etc.) configured to receive and process requests for data stored in memory devices of database 140 and to provide data from database 140.

Server 100 may also be communicatively connected to one or more user interface 150. User interface 150 may include a graphical interface (e.g., a display panel), an audio interface (e.g., a speaker), or a haptic interface (e.g., a vibration motor). For example, the display panel may include a liquid crystal display (LCD), a light-emitting diode (LED), a plasma display, a projection, or any other type of display. The audio interface may include microphones, speakers, and/or audio input/outputs (e.g., headphone jacks). In some embodiments, user interface 150 may be included in server 100. In some embodiments, user interface 150 may be included in a separate computer system. User interface 150 may be configured to display data transmitted from server 100.

In connection with server 100 as shown and described in FIG. 1, the systems and methods as described herein may provide a technical solution to technical problems in testing computer applications in a development phase. Aspects of this disclosure may relate to autonomous testing of a computer application, including systems, apparatuses, methods, and non-transitory computer-readable media. For ease of description, a system is described below, with the understanding that aspects to the system apply equally to methods, apparatuses, and non-transitory computer-readable media. For example, some aspects of such a system can be implemented by a system (e.g., server 100 and database 140), by an apparatus (e.g., server 100), as a method, or as program codes or computer instructions stored in a non-transitory computer-readable medium (e.g., memory 130 or another storage device of server 100). In a broadest sense, the system is not limited to any particular physical or electronic instrumentalities, but rather can be accomplished using many different instrumentalities.

Consistent with some embodiments of this disclosure, a system for autonomous testing of a computer application may include a non-transitory computer-readable medium configured to store instructions and at least one processor configured to execute the instructions to perform operations. A computer application, as used herein, may refer to a set of computer programs or modules (e.g., APIs) combined in a logical manner (referred to as an “API flow” in this disclosure) to implement a function (e.g., a financial service). In some embodiments, the computer application may be created, maintained, updated, or executed at a server computer of the system. In some cases, because the function may be implemented by multiple, different sequences of operations (referred to as “business flows” in this disclosure), the computer application may be implemented by multiple, different API flows.

By way of example, with reference to FIG. 1, the system may include server 100 and database 140. The at least one processor may be processor 110 in server 100. The non-transitory computer-readable medium may be memory 130 in server 100. The instructions stored in the non-transitory computer-readable medium may be used for implementing testing module 111 in server 100.

Consistent with some embodiments of this disclosure, the at least one processor of the system may perform operations of receiving analytic data associated with at least one application programming interface (API) flow. Receiving data, as used herein, may refer to accepting, taking in, admitting, gaining, acquiring, retrieving, obtaining, reading, accessing, collecting, or any operation for inputting the data.

An API flow in this disclosure may refer to a set of APIs combined in a logical manner. In some embodiments, an API flow of the at least one API flow may include at least one API. When the at least one API includes two or more APIs, the API flow may further include a sequence (e.g., a logic sequence) of the at least one API and a scheme for exchanging metadata between the at least one API. A scheme for exchanging metadata in this disclosure may include a design, definition, organization, or configuration that specifies a manner of exchanging the metadata. In some embodiments, the API flow may include a plurality of APIs interfaced in a sequence, in which the plurality of APIs may exchange metadata between each other in accordance with the scheme.

Analytic data associated with an API flow, as used herein, may refer to data representing an analysis of execution of the API flow. In some embodiments, the analytic data may include at least one of input-field data representing a characteristic (e.g., a value, a type, an order, or any characteristic) of an input field of the at least one API, status data representing whether the at least one API succeeds in execution, or validity data representing whether an internal conflict exists in the at least one API. In some embodiments, the status data and the validity data may include a textual string, an alphanumeric or symbolic code, or any data capable of representing a status and the validity, respectively. In some embodiments, the internal conflict may include an internal logic conflict that prevents implementation of the at least one API, such as incomplete composition of APIs, an incorrect sequence of the at least one API, or an incorrect scheme for exchanging the metadata between the at least one API.

Consistent with some embodiments of this disclosure, the at least one processor of the system may also perform operations of determining response data of the at least one API by inputting the analytic data to a prediction model determined based on a first machine learning technique. The prediction model may include an algorithm or a set of computer programs for predicting the response data as output with the analytic data as input.

In some embodiments, to determine the prediction model, the at least one processor of the system may perform operations of training the prediction model using the analytic data and the response data. The first machine learning technique may include a supervised learning technique (e.g., a support vector machine, a linear regression technique, a logistic regression technique, a Bayesian technique, a linear discriminant analysis technique, a decision tree technique, a k-nearest neighbor technique, or a neural network). For example, during the training process of the prediction model, historical response data and associated historical analytic data (e.g., at least one of historical input-field data, historical status data, or historical validation data) may be used as labeled training data. The prediction model under training may use the historical analytic data as input to determine inferred response data, and may use the historical response data associated with the inputted analytic data as labels. Based on the difference between the inferred response data and the labels, the at least one processor may update one or more parameters of the prediction model to reduce such difference in the next iteration of training.

Response data of an API, as used herein, may refer to data representing an output of the API if the at least one processor actually execute the API. In some embodiments, the at least one processor may determine the response data without actually executing the at least one API of the API flow.

In some embodiments, the response data may include at least one of: message data (e.g., a textual string) representing successful or failed execution of the at least one API, error-cause data (e.g., an alphanumeric or symbolic code) representing a cause of the failed execution of the at least one API, or error type data (e.g., any textual or numerical data) representing a type of the cause. For example, the message data of an API may include a textual string “Process Complete” that indicates successful execution of the API or a textual string “Process Error” that indicates failed execution of the API. In another example, the error-cause data may include one or more alphanumeric or symbolic codes (e.g., “Code 1,” “Error 335,” or “Err! #4”) representing predetermined meanings that indicate a cause of the failed execution of the API. As another example, the error type data may include a textual string (e.g., “Validation Error,” “Application Error,” or “Runtime Error”) that indicates a type of the cause of the failed execution. For example, the type of the cause may include a validation-type error representing that an internal conflict exists in the API, an application-type error representing that the API is corrupted (e.g., due to incorrect or missing configuration), or a runtime-type error representing that an error occurs when the at least one processor executes the API.

In some embodiments, based on the determined response data, the at least one processor may determine whether a further test is needed for the API. In some embodiments, the at least one processor of the system may perform operations of determining, based on the response data, whether to perform a test on the at least one API, and based on a determination to perform the test on the at least one API, outputting the at least one API for performing the test.

For example, if the response data indicate that an API would succeed in execution if it is actually executed, or if a cause of failed execution of the API would be clear (e.g., with known cause and error type) if the API is actually executed, the at least one processor may determine that no test is needed. Otherwise, the at least one processor may output the API for performing the test. For example, the test may need different testing data or a different testing environment to perform, or may be performed at a different time.

Consistent with some embodiments of this disclosure, the at least one processor of the system may further perform operations of determining a subset of the at least one API flow based on the response data and input data representing at least one of a priority level or a risk level of the at least one API flow. A priority level of an API flow in this disclosure may include data representing a level of priority or preference of the API flow. A risk level of an API flow in this disclosure may include data representing a level of risk or proneness to errors when actually executing the API flow. In some embodiments, the at least one processor may receive the input data before determining the subset of the at least one API.

In some embodiments, the subset of the at least one API flow may include the same number of API flows as or a smaller number of API flows than the at least one API. For example, based on the response data, the at least one processor may select one or more of the at least one API flow to form the subset, in which at least one API of an API flow of the at least one API flow may have message data representing successful execution, or error-cause data representing a less severe cause of failed execution, or error type data representing a less severe type of cause. In another example, the at least one processor may select an API flow that has fewer number of APIs in the at least one API flow if the response data of the at least one API flow are similar. By doing so, the at least one processor may effectively optimize the at least one API by selecting more efficient APIs or APIs less prone to errors.

Consistent with some embodiments of this disclosure, the at least one processor of the system may further perform operations of outputting the subset of the at least one API flow for execution. By way of example, the at least one processor may output the subset of the at least one API flow to an API flow executor (e.g., API flow executor 114 in FIG. 1) for execution. In another example, the at least one processor may output the subset of the at least API flow to a storage device (e.g., database 140 in FIG. 1) to be stored for future execution by the system (e.g., by processor 110 in FIG. 1).

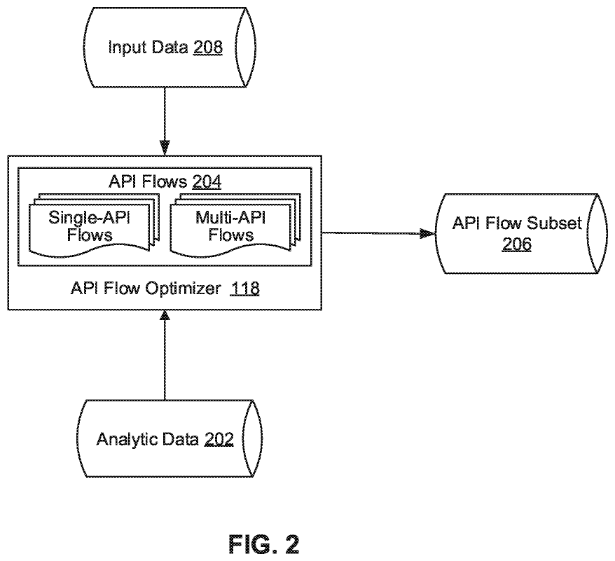

By way of example, FIG. 2 is a diagram of an example structure of API flow optimizer 118 for autonomous testing of a computer application, consistent with some embodiments of this disclosure. API flow optimizer 118 may be a part of testing module 111 in FIG. 1. In some embodiments, API flow optimizer 118 may receive analytic data 202 associated with multiple API flows 204. As illustrated in FIG. 2, in some embodiments, API flows 204 may include one or more single-API flows, each of which includes a single API, and one or more multi-API flows, each of which includes a plurality of APIs. For each API flow of API flows 204, API flow optimizer 118 may determine response data of APIs in the API flow by inputting analytic data 202 to a prediction model determined based on a supervised machine learning technique. API flow optimizer 118 may further determine API flow subset 206 from API flows 204 based on the response data and the input data 208 representing at least one of a priority level or a risk level of each of API flows 204. After that, API flow optimizer 118 may output API flow subset 206 for execution. For example, API flow subset 206 may be finalized as the implementations of the computer application as a result of the autonomous testing. In another example, API flow subset 206 may be used for determining new analytic data for a next-round optimization, in which API flow optimizer 118 may increase robustness of selected API flows in the subset, increase the overall test coverage, and provide adaptability of the optimization.

Consistent with some embodiments of this disclosure, to determine the at least one API flow, the at least one processor of the system may further perform operations of determining the at least one API flow in response to receiving an input API flow that includes a plurality of APIs and specification data associated with of the plurality of APIs. The plurality of APIs may include the at least one API in the at least one API flow. The at least one processor may then output the at least one API flow for execution.

An input API flow in this disclosure may include a previously determined API flow that may implement the computer application. In some embodiments, the input API flow may be stored in a database, and the at least one processor may receive it from the database. Specification data associated with an API, as used herein, may refer to data representing a scheme, definition, design, format, style, rule, type, configuration, or any protocol for specifying a structure for organizing information (e.g., a parameter or a data field) in the API for storage or transmission. For example, the specification data may include specification data associated with each API of the plurality of APIs. As examples, the specification data may be in a Swagger format or a web services description language (WSDL) format if the APIs in the at least one API flow is in a representational state transfer (REST) format or a simple object access protocol (SOAP) format, respectively. In some embodiments, the specification data may be stored in a dedicated storage device or system (referred to as a “test accelerator” in this disclosure), and the at least one processor may receive the specification data from the test accelerator.

In some embodiments, after receiving the input API flow, the at least one processor may determine, without any human intervention, a mapping relationship between a business flow corresponding to the computer application and the input API flow, the composition of the plurality of APIs of the input API flow, a sequence of the plurality of APIs, and a scheme for metadata exchange between the plurality of APIs. The at least one processor may determine all possible API flows by re-combining or rearranging one or more of the plurality of APIs for implementing the computer application, and such API flows may have different compositions, sequences, or schemes with the input API flow. In some embodiments, the at least one API flow may include all API flows (e.g., all possible or permitted API flows) capable of implementing the computer application, and each API flow of the at least one API flow may have a different sequence or composition of the plurality of APIs.

In some embodiments, if the input API flow has any change (e.g., a change in API composition, sequence, or metadata-exchange scheme), the at least one processor may update the at least one API flow in accordance with the change to increase adaptability of generating the at least one API flow. In some embodiments, the at least one processor of the system may further perform operations of updating the at least one API flow in response to receiving data representing a change in the input API flow. Data representing a change in an API flow in this disclosure may include data representing a change in API composition of the API flow, an API sequence of the API flow, a metadata-exchange scheme of the API flow, or in any other data field or parameter of the API flow.

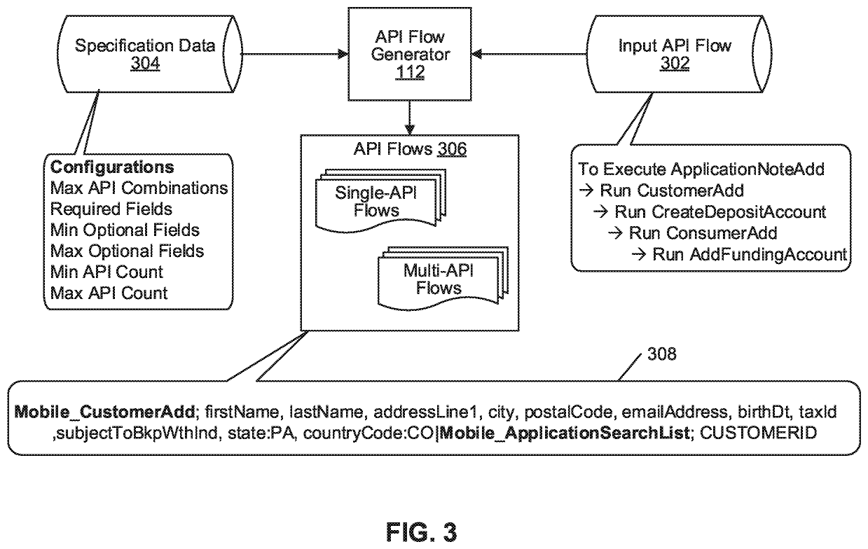

By way of example, FIG. 3 is a diagram of an example structure of API flow generator 112 for autonomous testing of a computer application, consistent with some embodiments of this disclosure. API flow generator 112 may be a part of testing module 111 in FIG. 1. In some embodiments, API flow generator 112 may receive an input API flow 302 (named “ApplicationNoteAdd”) that includes a plurality of APIs. As illustrated in FIG. 3, as an example, the plurality of APIs include “CustomerAdd,” “CreateDepositAccount,” “ConsumerAdd,” and “AddFundingAccount.” API flow generator 112 may also receive specification data 304 associated with the plurality of APIs. As illustrated in FIG. 3, as an example, specification data 304 include configurations of “Max API Combinations,” “Required Fields,” “Min Optional Fields,” “Max Optional Fields,” “Min API Count,” and “Max API Count.”

API flow generator 112 may then determine API flows 306 based on the specification data and the plurality of APIs. For example, each of the API flows 306 may have a different sequence or composition of the plurality of APIs. In some embodiments, API flows 306 may include one or more single-API flows, each of which includes a single API, and one or more multi-API flows, each of which includes a plurality of APIs. As illustrated in FIG. 3, as an example, API flows 306 includes a multi-API flow 308 that includes 2 APIs (i.e., “Mobile_CustomerAdd” and “Mobile_ApplicationSearchList”). API flow generator 112 may further output API flows 306 for execution.

Consistent with some embodiments of this disclosure, to execute the at least one API flow, the at least one processor of the system may further perform operations of generating test data for executing the API flow in response to receiving the API flow of the at least one API flow, and determining execution data of the API flow by executing the API flow using the test data. The execution data may include an execution result of the API flow and at least one API output of the at least one API of the API flow. In some embodiments, the at least one processor may execute all of the at least one API flow after generating the test data for executing the same.

Test data of an API flow, as used herein, may refer to data used for executing the API flow for a purpose of testing (e.g., not for production or actual services). For example, for a computer application implemented to perform a money transfer, the test data may include a tax identification number, a name, an address, a date or birth, an account balance, or any other data related with the money transfer. Execution data of an API flow in this disclosure may include any data, information, or result outputted by the API flow after it is being executed. Executing an API flow, as used herein, may refer to a process of inputting the test data to the API flow as input and execute (e.g., in a test environment setup) program codes or instructions corresponding to the API flow. An execution result of an API flow, as used herein, may refer to final outputted data after all operations or procedures of the API are completed. An API output of an API, as used herein, may refer to immediate output data of the API after completing executing the API.

In some embodiments, the at least one processor may store the execution data in a database. In some embodiments, the at least one processor may store the execution data at an API-flow level (e.g., the execution result) and an API level (e.g., the at least one API output). By way of example, the database may be database 140 in FIG. 1.

As described above, the at least one processor may generate the test data dynamically (e.g., at runtime of the API flow) at a test accelerator. By doing so, execution of the at least one API flow may be automated without any human intervention.

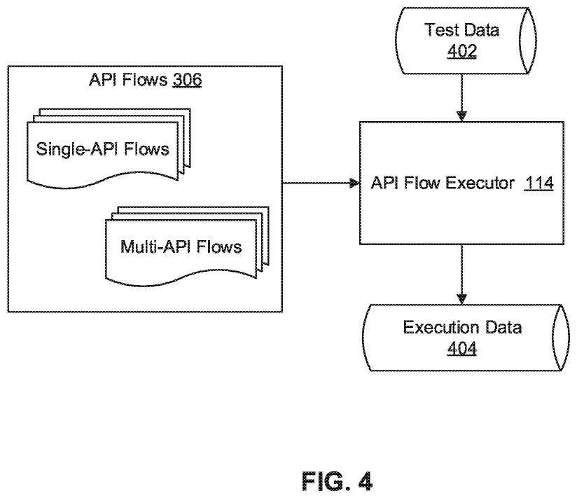

By way of example, FIG. 4 is a diagram of an example structure of API flow executor 114 for autonomous testing of a computer application, consistent with some embodiments of this disclosure. API flow executor 114 may be a part of testing module 111 in FIG. 1. In some embodiments, in response to receiving an API flow (e.g., API flow 308 in FIG. 3) of API flows 306, API flow executor 114 may generate test data 402 for executing the API flow. API flow executor 114 may then determine execution data 404 of the API flow by executing the API flow using test data 402. In some embodiments, the at least one processor may further store execution data 404 in database 140 of FIG. 1.

For example, for a computer application implemented to perform a money transfer, test data 402 may include a tax identification number, a name, an address, a date or birth, an account balance, or any other data related with the money transfer. The at least one processor of the system may generate test data 402 using fake data that is not connected to actual business or actual users. For example, the fake data may be generated using a random generator or using a data template. It should be noted that test data 402 may be generated using various manners, and this disclosure does not limit such manners to the above-described examples.

Consistent with some embodiments of this disclosure, to determine the analytic data associated with the at least one API flow (e.g., including at least one of status data representing whether the at least one API succeeds in execution, or validity data representing whether an internal conflict exists in the at least one API), the at least one processor of the system may further perform operations of, in response to receiving the execution data, determining the analytic data by inputting the execution data to a clustering model determined based on a second machine learning technique. In some embodiments, the at least one processor may receive the execution data from the database that stores the execution data. The clustering model may be used for determining one or more clusters, groups, or categories from sample data. For example, the clustering model may include an agglomerative Manhattan clustering model. In some embodiments, the second machine learning technique may include an unsupervised learning technique (e.g., a k-means technique or a hierarchical clustering technique). In some embodiments, the at least one processor may determine a pattern from the execution data using the clustering model. Based on the pattern, the at least one processor may categorize the at least one API flows. By performing the categorizing, the at least one processor may be enabled to identify importance levels for the at least one API flows, evaluate impact of a failed API flow in the at least one API flow, or analyze relationships and dependencies in the at least one API flow.

By way of example, Table 1 illustrates example analytic data and execution data for two API flows, consistent with some embodiments of this disclosure. As illustrated in Table 1, the first and second API flows have two and three APIs (shown in bold texts in the column of “API Flow”), respectively. The execution results of the first and second API flows are 1 and 0, respectively. The first API flow succeeds in its execution (e.g., represented by a status code “200”), but the second API flow fails in its execution (e.g., represented by a status code “400”). The cause of the failed execution of the second API is failure in executing its API “Mobile_CreateDepositAccount.” By way of example, the execution data of the two API flows may include the columns “Execution Result” and “Error Cause,” and the analytic data of the two API flows may include the columns “Total APIs” and “Status Code.”

TABLE 1

| | | Execution | | Status |
|---|---|---|---|---|
| API Flow | Total APIs | Result | Error Cause | Code |
| Mobile_CustomerAdd; | 2 | 1 | | 200 |
| firstName, lastName, | | | | |
| countryCode:CO \| | | | | |
| Mobile_ApplicationSearchList; | | | | |
| CUSTOMER | | | | |
| Mobile_CustomerAdd; | 3 | 0 | Mobile_CreateDepositAccount | 400 |
| firstName, lastName, state:PA \| | | | | |
| Mobile_CreateDepositAccount; | | | | |
| CUSTOMERID, ACCOUNTTITLE, | | | | |
| CODE:USD \| | | | | |
| BillPay_ConsumerAdd; | | | | |
| USERID | | | | |

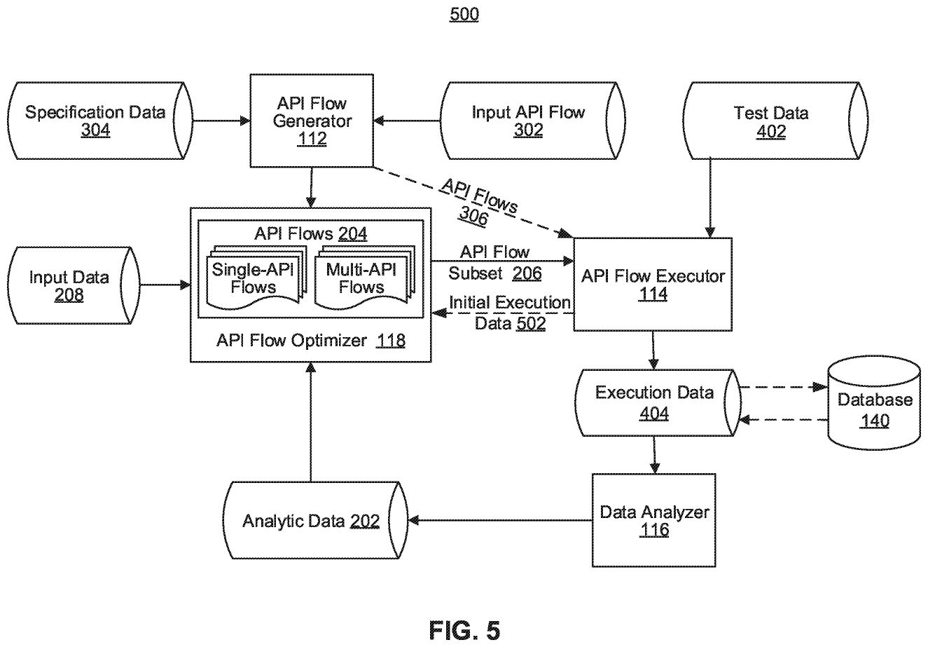

By way of example, FIG. 5 is a flow diagram 500 involving testing module 111 in the system shown in FIG. 1 for autonomous testing of a computer application, consistent with some embodiments of this disclosure. As illustrated in FIG. 5, testing module 111 includes API flow generator 112, API flow executor 114, data analyzer 116, and API flow optimizer 118. An autonomous testing procedure may be performed in an iterative manner described as follows.

In some embodiments, in an initial iteration of flow diagram 500, API flow generator 112 may receive input API flow 302 that includes a plurality of APIs and specification data 304 associated with the plurality of APIs and determine API flows 306 (shown above a dashed arrow between API flow generator 112 and API flow executor 114 in FIG. 5). API flow executor 114 may receive API flows 306 and generated test data 402, and determine initial execution data 502 (shown above a dashed arrow between API flow executor 114 and API flow optimizer 118 in FIG. 5) by executing API flows 306 using test data 402. Initial execution data 502 may include execution results of API flows 306 and an API output (e.g., including at least one of message data, error-cause data, or error type data) of the API for each API in API flows 306. API flow optimizer 118 may receive initial analytic data (e.g., including only input-field data, not shown in FIG. 5) associated with API flows 306.

Based on initial execution data 502 (e.g., at least one API output of at least one API of API flows 306) and the initial analytic data, API flow optimizer 118 may train a prediction model (not shown in FIG. 5) using a supervised machine learning technique. For example, during the training process of the prediction model, API flow optimizer 118 may use initial execution data 502 (e.g., at least one of the execution results or the API outputs of API flows 306) and the initial analytic data (e.g., the input-field data) as labeled training data. The prediction model under training may use the initial analytic data as input to determine inferred response data (e.g., including at least one of message data, error-cause data, or error type data), and may use initial execution data 502 as labels. Based on the difference between the inferred response data and the labels, API flow optimizer 118 may update one or more parameters of the prediction model to reduce such difference in the next iteration of training. When the difference between the inferred response data and the labels satisfies a predetermined condition (e.g., a difference value between them being smaller than a threshold value), the training of the prediction model may be completed.

API flow optimizer 118 may further determine API flows 204 based on initial execution data 502 (e.g., at least one API output of at least one API of API flows 306) and received input data 208. API flows 204 may be a subset of API flows 306. API flow optimizer 118 may then output API flows 204 to API flow executor 114 for execution (not illustrated in FIG. 5).

In a second iteration following the initial iteration, API flow executor 114 may receive API flows 204 and generated test data 402, and determine execution data 404 by executing API flows 204 using test data 402. In some embodiments, execution data 404 may be stored to and retrieved from database 140 (represented by two dash arrows between execution data 404 and database 140). Data analyzer 116 may receive execution data 404 and determine analytic data 202 (e.g., including at least one of input-field data, status data, or validity data) by inputting execution data 404 to a clustering model (not shown in FIG. 5) determined based on an unsupervised machine learning technique. API flow optimizer 118 may receive analytic data 202 associated with API flows 204 and input analytic data 202 to the prediction model (not shown in FIG. 5) to determine response data (not shown in FIG. 5) of each API in API flows 204. API flow optimizer 118 may further determine API flow subset 206 (shown above a dashed arrow between API flow optimizer 118 and API flow executor 114 in FIG. 5) based on the response data and received input data 208, and output API flow subset 206 to API flow executor 114 for execution. API flow subset 206 may be a subset of API flows 204.

In the following iterations, API flow executor 114, data analyzer 116, and API flow optimizer 118 may repeat operations similar to their respective operations in the second iteration, and the number of API flows in API flow subset 206 may be maintained the same or decreased in each iteration. In some embodiments, when a predetermined condition is met (e.g., the number of API flows in API flow subset 206 are stable after a predetermined number of iterations), testing module 111 may terminate the iterations and output the final API flow subset 206 as optimized API flows for implementing the computer application.

Consistent with some embodiments of this disclosure, each component (e.g., API flow generator 112, API flow executor 114, data analyzer 116, and API flow optimizer 118) of testing module 111 may be implemented as modular and independent, and may be executed individually or as part of an integrated technical solution. As illustrated in FIG. 5, testing module 111 may be built and utilized as a continuous learning module that improves its performance as the number of iteration increases.

By implementing testing module 111 that includes API flow generator 112, API flow executor 114, data analyzer 116, and API flow optimizer 118 as illustrated and described in association with FIGS. 1-5, the autonomous testing of the computer application may be achieved without any human intervention. Such an autonomous testing solution may depend on no specific testing script or programming skill in any way, and may provide a structured and customizable solution for designing and maintaining the testing schemes of the computer application in its development phase.

The data analytics feature (e.g., implemented by data analyzer 116) of the autonomous testing solution may enhance understanding of causes of failed API flows and their impact on the computer application. The continuous learning feature (e.g., implemented by API flow optimizer 118) of the autonomous testing solution may identify more efficient and robust API flows for implementing the computer application, and automatically prevent inefficient or erroneous API flows from being repeatedly used in the testing. The full scenario coverage feature (e.g., implemented by API flow generator 112) of the autonomous testing solution may ensure higher quality and fewer defects in the computer application under test.

By removing dependency from human intervention, the technical solutions provided in this disclosure may decrease product development costs in designing test scripts and maintaining the test execution. By removing dependency from any specific automation framework or any specific programming language, the technical solution provided herein can be independent of any framework environment (e.g., licensed automation tools) and users of any programming skills. By providing input-dependent, dynamic adaptability to API flows (e.g., implemented by API flow generator 112), the technical solution provided herein may offer more responsive and faster adjustments and risk evaluations to the testing in case of improvements of the computer application. By providing clear relationships and dependencies between API flows and corresponding testing (e.g., implemented by API flow optimizer 118), the technical solutions provided in this disclosure may assist identifying regression issues in testing when source code of the computer application is updated.

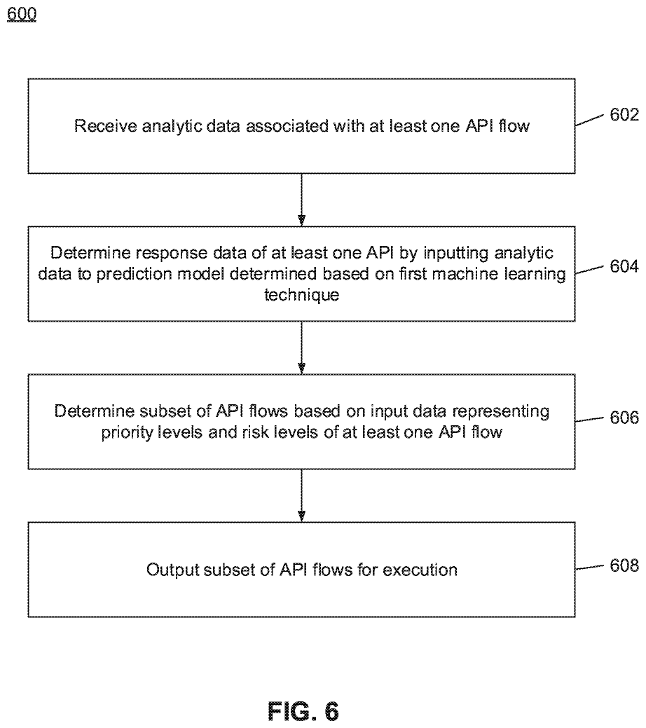

By way of example, FIG. 6 is a flowchart of an example process 600 for autonomous testing of a computer application using the system shown in FIG. 1, consistent with some embodiments of this disclosure. The system (e.g., server 100 and database 140) may include a memory (e.g., memory 130) that stores instructions and a processor (e.g., processor 110) programmed to execute the instructions to implement process 600. For example, process 600 may be implemented as one or more software modules (e.g., testing module 111 that includes API flow generator 112, API flow executor 114, data analyzer 116, and API flow optimizer 118) stored in memory 130 and executable by processor 110.

Referring to FIG. 6, at step 602, the processor may receive (e.g., at API flow optimizer 118 in FIG. 1, 2, or 5) analytic data (e.g., analytic data 202 in FIG. 2 or 5) associated with at least one application programming interface (API) flow (e.g., API flows 204 in FIG. 2 or 5, or API flows 306 in FIG. 3). An API flow (e.g., API flow 308 in FIG. 3) of the at least one API flow may include at least one API (e.g., 1, 2, 3, 50, 60, or any number of APIs). In some embodiments, if the at least one API includes two or more APIs, the API flow may further include a sequence of the at least one API and a scheme for exchanging metadata between the at least one API. In some embodiments, the analytic data may include at least one of input-field data representing a characteristic (e.g., a value, a type, an order, or any characteristic) of an input field of the at least one API, status data (e.g., the column “Status Code” in Table 1) representing whether the at least one API succeeds in the execution, or validity data representing whether an internal conflict exists in the at least one API.

In some embodiments, the processor may determine (e.g., at API flow generator 112 in FIG. 1, 3, or 5) the at least one API flow in response to receiving an input API flow (e.g., input API flow 302 in FIG. 3 or 5) that includes a plurality of APIs and specification data (e.g., specification data 304 in FIG. 3 or 5) associated with of the plurality of APIs. The plurality of APIs may include the at least one API. The processor may further output (e.g., to API flow executor 114 in FIG. 1, 4, or 5) the at least one API flow for execution. In some embodiments, the at least one API flow may include all API flows capable of implementing the computer application, and each API flow of the at least one API flow may have a different sequence or composition of the plurality of APIs. In some embodiments, the processor may update the at least one API flow in response to receiving data representing a change in the input API flow.

In some embodiments, to execute the at least one API flow, the processor may generate test data (e.g., test data 402 in FIG. 4 or 5) for executing the API flow in response to receiving (e.g., at API flow executor 114) the API flow of the at least one API flow, and determine (e.g., at API flow executor 114) execution data (e.g., execution data 404 in FIG. 4 or 5) of the API flow by executing the API flow using the test data, in which the execution data may include an execution result (e.g., the column “Execution Result” in Table 1) of the API flow and at least one API output of the at least one API of the API flow. In some embodiments, the processor may store the execution data in a database (e.g., database 140 in FIG. 1 or 5).

In some embodiments, in response to receiving (e.g., at data analyzer 116 in FIG. 1 or 5) the execution data, the processor may determine (e.g., at data analyzer 116) the analytic data by inputting the execution data to a clustering model determined based on a second machine learning technique (e.g., an unsupervised machine learning model).

Still referring to FIG. 6, at step 604, the processor may determine (e.g., at API flow optimizer 118) response data of the at least one API by inputting the analytic data to a prediction model determined based on a first machine learning technique (e.g., a supervised machine learning technique). In some embodiments, the response data may include at least one of: message data representing successful or failed execution of the at least one API, error-cause data (e.g., the column “Error Cause” in Table 1) representing a cause of the failed execution of the at least one API, or error type data representing a type of the cause.

In some embodiments, the processor may train the prediction model using the analytic data and at least one API output of the at least one API of the API flow. In some embodiments, the processor may determine, based on the response data, whether to perform a test on the at least one API, and output the at least one API for performing the test based on a determination to perform the test on the at least one API.

At step 606, the processor may determine (e.g., at API flow optimizer 118) a subset (e.g., API flow subset 206 in FIG. 2 or 5) of the at least one API flow based on the response data and input data (e.g., input data 208 in FIG. 2 or 5) representing at least one of a priority level or a risk level of the at least one API flow.

At step 608, the processor may output (e.g., to API flow executor 114 in FIG. 1, 4, or 5) the subset of the at least one API flow for execution.

A non-transitory computer-readable medium may be provided that stores instructions for a processor (e.g., processor 110) for autonomous testing of a computer application in accordance with the example flowchart of FIG. 6 above, consistent with embodiments in the present disclosure. For example, the instructions stored in the non-transitory computer-readable medium may be executed by the processor for performing process 600 in part or in entirety. Common forms of non-transitory media include, for example, a floppy disk, a flexible disk, hard disk, solid-state drive, magnetic tape, or any other magnetic data storage medium, a Compact Disc Read-Only Memory (CD-ROM), any other optical data storage medium, any physical medium with patterns of holes, a Random Access Memory (RAM), a Programmable Read-Only Memory (PROM), and Erasable Programmable Read-Only Memory (EPROM), a FLASH-EPROM or any other flash memory, Non-Volatile Random Access Memory (NVRAM), a cache, a register, any other memory chip or cartridge, and networked versions of the same.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1.-22. (canceled)

23. A system for autonomous testing of a computer application, comprising:
a non-transitory computer-readable medium configured to store instructions; and at least one processor configured to execute the instructions to perform operations comprising:
receiving at least one API flow from a plurality of API flows;
generating test data for executing the at least one API flow;
determining execution data of the at least one API flow, wherein the determining comprises executing the at least one API flow using the test data; and
determining analytic data by inputting the execution data to a clustering model.

24. The system of claim 23, the generating test data further comprising generating fake data using a random generator.

25. The system of claim 23, further comprising determining a pattern from the execution data using the clustering model.

26. The system of claim 25, further comprising categorizing the at least one API flows based on the pattern.

27. The system of claim 26, further comprising, based on the categorizing, determining at least one of:
importance levels for the at least one API flows;
impact of a failed API flow in the at least one API flows; or
dependency on the at least one API flows.

28. The system of claim 23, wherein each API flow of the at least one API flows has a different sequence of composition of the plurality of API flows.

29. The system of claim 23, wherein, the test data comprises at least one of a tax identification number, a name, an address, a date of birth, or an account balance.

30. The system of claim 23, wherein the execution data is stored in a database.

31. A computer-implemented method for autonomous testing of a computer application, comprising:
receiving at least one API flow from a plurality of API flows;
generating test data for executing the at least one API flow;
determining execution data of the at least one API flow, wherein the determining comprises executing the at least one API flow using the test data; and
determining analytic data by inputting the execution data to a clustering model.

32. The method of claim 31, wherein the operations further comprise:
training a prediction model using a supervised machine learning technique;
determining an inferred response data based on the prediction model;
updating at least one parameter of the prediction model based on the response data.

33. The method of claim 32, wherein the operations further comprise completing training of the prediction model upon determining that the inferred response data meets a predetermined threshold.

34. The method of claim 32, wherein the prediction model uses initial execution data and the initial analytic data as training data.

35. The method of claim 34, wherein the initial analytic data is determined by inputting execution data to a clustering model.

36. The method of claim 32, wherein the response data comprises at least one message data, error-cause data, or error type data.

37. The method of claim 32, wherein the initial execution data is stored in and retrieved from a database.

38. The method of claim 32, wherein the method continued for a predetermined number of iterations.

39. The method of claim 31, wherein the plurality of API flows includes a subset comprising at least one API flow.

40. The method of claim 39, wherein the number of API flows within the subset stabilizes after a predetermined number of iterations, terminating the iterations.

41. The method of claim 31, further comprising updating the at least one API flow in response to receiving data representing a change in the at least one API flow.
